(19) United States
(12) Patent Application Publication
(10) Pub. No.: US 2010/0103092 A1
(43) Pub. Date: Apr. 29, 2010

(54) Video-based handwritten character input apparatus and method thereof

(75) Inventors: Chen-Chiung HSIEH, Pingjhen City (TW); Ming-Ren TSAI, Taipei City (TW); Dung-Hua LIOU, Keelung City (TW)

Correspondence Address: BACON & THOMAS, PLLC, 625 SLATERS LANE, FOURTH FLOOR, ALEXANDRIA, VA, 22314-1176, US

(73) Assignees: Tatung University, Taipei (TW); Tatung Company, Taipei (TW)

(21) Appl. No.: 12/379,388

(22) Filed: Feb. 20, 2009

(30) Foreign Application Priority Data
Oct. 23, 2008 (TW) 097140620

(51) Int. Cl. G06F 3/03

(52) U.S. Cl. 345/156

(57) ABSTRACT

A video-based character input apparatus includes an image capturing unit, an image processing unit, a one-dimensional feature coding unit, a character database, a character recognizing unit, a display unit, and a stroke feature database. The image capturing unit captures an image. The image processing unit filters a moving track of a fingertip in the picture by detecting a graphic difference, then detecting a skin color and picking out a moving track most corresponding to a point of the object. The one-dimensional feature coding unit takes a stroke with respect to the moving track and converts the stroke into a coding sequence in a one-dimensional string according to a time sequence. The character recognizing unit proceeds with character comparison between the coding sequence in a one-dimensional string and the character database to find out a character having the most similarity for display one the display unit.

### BACKGROUND OF THE INVENTION

1. Field of the Invention

The present invention relates to a character input apparatus and, more particularly, to a video-based handwritten character input apparatus.

2. Description of Related Art

Recently, with the progress of science and technology, almost all the electronic products are developed to have light weight, small volume and powerful performance, such as a PDA, a mobile phone and a notebook computer. However, the shrinkage of the volume causes difficulty in engaging with an input device often used in the past and having a bigger size, such as a tablet, a keyboard, a mouse and a joystick, rendering degraded portability. Therefore, it is an important issue on how to conveniently input information in a portable electronic product.

In order to facilitate people to conveniently input information, it is prosperously developed in research for various kinds of interactive human-machine interfaces. The most convenient way of inputting a character is to directly use a gesture motion for operating a computer or to use hand-writing by a fingertip. In order to detect the gesture motion or the position of the fingertip, a glove-based approach of using a glove is submitted, in which a data glove equipped with a sensor is used, capable of accurate perception of a lot of data regarding the gesture motion of a user, including contact and curvature of the finger, the rotation degree of a wrist, and so on. The advantage thereof is capable of obtaining accurate gesture information, but the disadvantages thereof are high cost and limitation of the activity range, while burdening on the user when wearing such equipment on the hand.

Another video-based approach may be classified into two kinds, one being based on establishing a model, and the other being based on shape information of an appearing contour. The approach based on establishing a model uses more than two cameras to take pictures of hand's motions, then to calculate the position in a 3D space of a hand, and further to compare with a 3D model built in advance, thereby obtaining the current hand's motion or the position of the fingertip. However, such an approach requires a lot of calculations, and can hardly be applied in a real time. The existing commonly used approach is based on the shape information of an appearing contour, in which a single camera is used to take pictures of the of hand's motions, the information regarding the edge or shape of a hand is sliced and taken out, and such information is based to verify the hand's gesture or to judge the position of fingertip. Since not many calculations are required, it becomes a popular, commonly-used approach recently.

After obtaining the information of the hand's motions or the track of the handwritten character, it is required to proceed with verification on the hand's motions or the handwritten character. There are three commonly-used ways as follows: a hidden Markov model, a neural network and a dynamic time warp matching algorithm, in which the rate of verification for the way of the dynamic time warp matching algorithm is the highest, while the time taken thereby is rather longer. In view of this, according to the present invention, some basic strokes for constructing a character are defined, including eight direction strokes, eight curvature strokes and two circle strokes, with which a one-dimensional series of all the possible strokes are assembled, and character's comparison is made using the dynamic time warp matching algorithm, capable of tolerating input, deletion and substitution of a stroke, thereby enhancing performance of comparison to obtain the effect of the real-time verification.

### SUMMARY OF THE INVENTION

An object of the present invention is to provide a video-based character input apparatus, comprising: an image capturing unit, an image processing unit, a one-dimensional feature coding unit, a character recognizing unit, a display unit, a stroke feature database and a character database. Among which, the image capturing unit is used for capturing an image; the image processing unit is used for filtering a moving track of an object in the image, the object may be a fingertip, and the procedures include: firstly detecting a graphic difference, then detecting a skin color, and finally picking out a moving track most corresponding to a point of the object; the stroke feature database stores various strokes and their corresponding codes; the one-dimensional feature coding unit is used for taking a stroke with respect to the moving track and converting the stroke into a coding sequence in a one-dimensional string according to a time sequence and the kinds of strokes include strokes in eight directions, semi-circles, and circles; the character database is used for storing characters, including Chinese, English, digits and symbols; the character recognizing unit is used for proceeding with character comparison between the coding sequence in a one-dimensional string and the character database to find out a character having the most similarity; and the display unit is used for displaying the character found out by the character recognizing unit.

The image capturing unit includes a network camera, an image capturing device in a mobile device, and an image capturing device in an embedded device. The character recognizing unit proceeds with character comparison using a dynamic time warp matching algorithm. Thus, the objective and effect of effectively recognizing video-based handwritten characters and inputting characters can be achieved using the video-based character input apparatus of the invention.

A further object of the invention is to provide a method for inputting a character in a video-based character input apparatus, in which the video-based character input apparatus includes an image capturing unit, an image processing unit, a one-dimensional feature coding unit, a character recognizing unit, a display unit, a stroke feature database for storing various strokes and their corresponding codes and a character database for storing Chinese, English, digits and symbols. According to the method, the image capturing unit is to capture an image; the image processing unit is to filter a moving track of an object in the picture, the object may be a fingertip, and the procedures include: firstly detecting a graphic difference, then detecting a skin color, and finally picking out a moving track most corresponding to a point of the object; the one-dimensional feature coding unit is to take a stroke with respect to the moving track, to search the stroke feature database and to convert the stroke into a coding sequence in a one-dimensional string according to a time sequence, in which the kinds of strokes include strokes in eight directions, semi-circles, and circles; the character recognizing unit is to proceed with character comparison between the coding sequence in a one-dimensional string and the character database to find out a character having the most similarity; and the display unit is to display the character found out by the character recognizing unit.

The image capturing unit includes a network camera, an image capturing device in a mobile device, and an image capturing device in an embedded device. The character recognizing unit proceeds with character comparison using a dynamic time warp matching algorithm. Thus, the objective and effect of effectively recognizing video-based handwritten characters and inputting characters can be achieved using the method for inputting a character in the video-based character input apparatus of the invention.

Other objects, advantages, and novel features of the invention will become more apparent from the following detailed description when taken in conjunction with the accompanying drawings.

### BRIEF DESCRIPTION OF THE DRAWINGS

FIG. 1 is a structural diagram showing a video-based character input apparatus according to a preferred embodiment of the invention;

FIGS. 2(A)-(B) are schematic diagrams showing coding of kinds of strokes according to a preferred embodiment of the invention;

FIG. 3 is a schematic diagram showing procedures of recognizing a character according to a preferred embodiment of the invention;

FIG. 4 is a schematic diagram showing a stroke cut according to a preferred embodiment of the invention;

FIG. 5 is a schematic diagram showing a gesture respectively for writing and beginning to write according to a preferred embodiment of the invention;

FIG. 6 is a flow chart showing a video-based character input method according to a preferred embodiment of the invention; and

FIG. 7 is an exploded view of procedures for recognizing a character of 6 according to a preferred embodiment of the invention.

### DETAILED DESCRIPTION OF THE PREFERRED EMBODIMENT

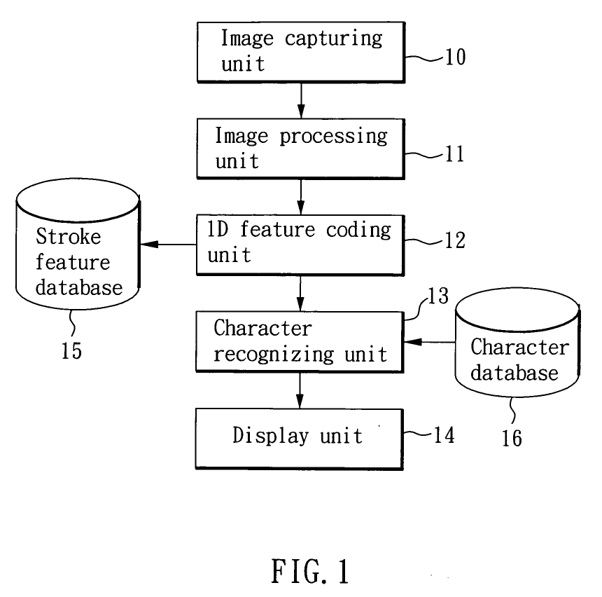

To facilitate understanding technical contents of the invention, a video-based character input apparatus is particularly submitted and explained as follows. Please refer to FIG. 1, which is a structural diagram showing a video-based character input apparatus according to a preferred embodiment of the invention. The video-based character input apparatus comprises an image capturing unit 10, an image processing unit 11, an one-dimensional feature coding unit 12, a character recognizing unit 13, a display unit 14, a stroke feature database 15 and a character database 16. The image capturing unit 10, such as a network camera, an image capturing device in a mobile device, and a image capturing device in an embedded device, is used for capturing an input image. The image processing unit 11 proceeds with firstly detecting a graphic difference, then detecting a skin color, and finally filtering an object in the image, such as a moving track of a fingertip.

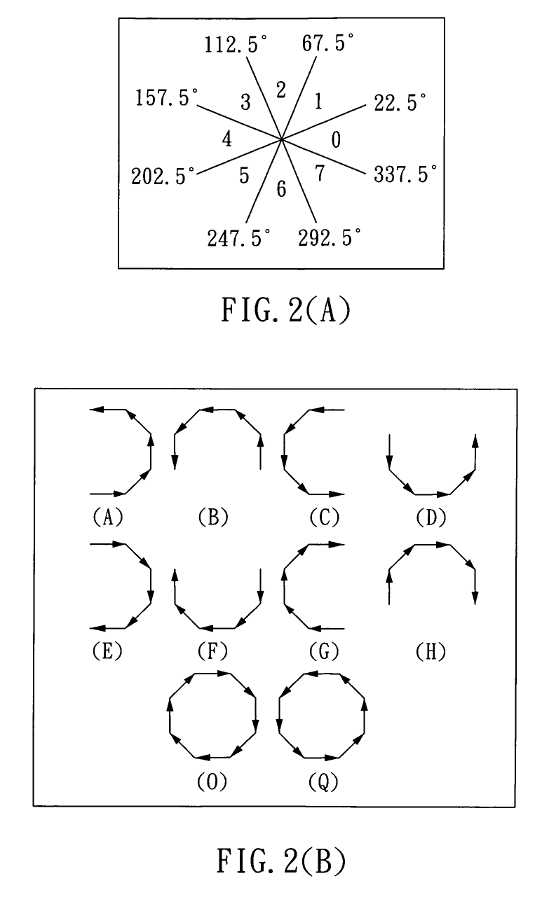

The one-dimensional feature coding unit 12 is used for taking a stroke with respect to the moving track. Please refer to FIGS. 2(A)-(B), which are schematic diagrams showing coding of kinds of strokes according to a preferred embodiment of the invention. The coding of kinds of strokes is based to construct a fundamental stroke for a character model, including strokes in eight directions (0-7 in FIG. 2(A)), eight strokes in semi-circle ((A)-(H) in FIG. 2(B)), and two strokes in circle ((O) and (Q) in FIG. 2(B)), which are all stored in the stroke feature database 15. Based on a one-dimensional on-line model, the one-dimensional feature coding unit 12 converts the stroke into a coding sequence in a one-dimensional string according to a time sequence. The character recognizing unit 13 is used for proceeding with character comparison between the coding sequence in a one-dimensional string and characters stored in the character database 16, including such as Chinese, English, digits and symbols, to find out a character having the most similarity and outputs the same to the display unit 14 for displaying, using a dynamic time warp matching algorithm.

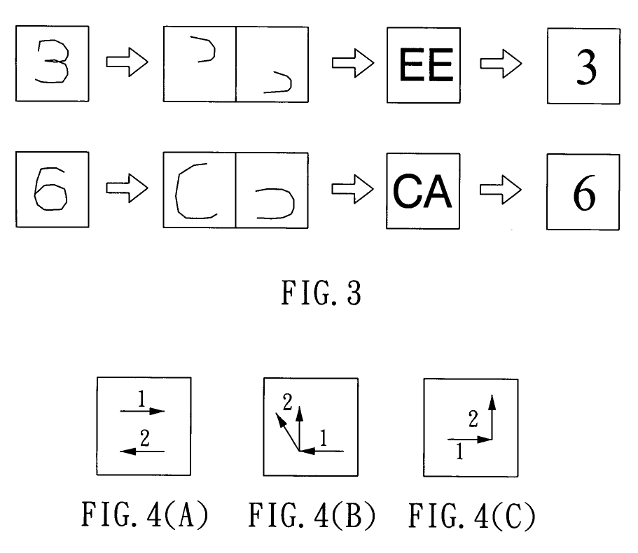

Please refer to FIG. 3, which is a schematic diagram showing procedures of recognizing a character according to a preferred embodiment of the invention. The digits “3” and “6” are exampled to generally interpret the procedures for character verification. Firstly, the image processing unit 11 filters out moving tracks of “3” and “6” written by a fingertip of a user before a camera. Based on the one-dimensional on-line model and the kinds of strokes, the one-dimensional feature coding unit 12 converts the stroke into a coding sequence in a one-dimensional string according to a time sequence. Please refer to FIG. 2(B) concurrently. The strokes of “3” comprise two clockwise arc strokes (semi-circle strokes), i.e. “ [symbol] ”, each corresponding to a code “E”. Thus, the one-dimensional coding sequence of “3” is “EE”. The strokes of “6” comprise two counter-clockwise arc strokes, i.e. “ [symbol] ” and “ [symbol] ”, respectively corresponding to codes “C” and “A”. Thus, the one-dimensional coding sequence of “6” is “CA”. Finally, the character recognizing unit 13 proceeds with character comparison of each of “EE” and “CA” with the coding of the characters stored in the character database 16, to find out the character respectively of “3” and “6”, and outputs the same to the display unit 14 for displaying, using the dynamic time warp matching algorithm.

Please refer to FIG. 4, which is a schematic diagram showing a stroke cut according to a preferred embodiment of the invention. In fact, the stroke track of a character handwritten by a fingertip is not completely the same as that written by holding a pen. When writing a character by the fingertip, due to that a continuous movement(s) of the finger between a stroke and a next stroke, a redundant stroke(s) will be produced, resulting in increase of difficulty in verification. Taking the English character “E” as an example, the sequence of strokes is “→” “↓” “→” “→”. However, when writing the character by the fingertip, a surplus stroke of “←” between the first stroke “→” and the next stroke “↓” will be produced due to movements of the fingertip. To solve this problem, according to the invention, some conditions causing a redundant stroke(s) will be defined as a stroke cut, such as the schematic diagrams shown in FIGS. 4(A)-(C), thereby increasing accuracy of the stroke and further enhancing verification rate of the character.

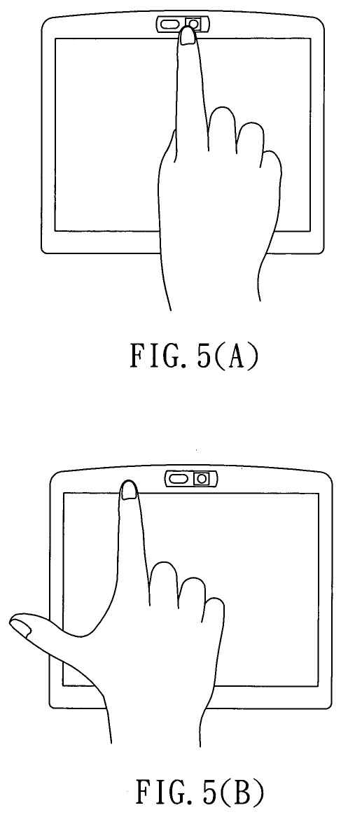

Please refer to FIG. 5, which is a schematic diagram showing a gesture respectively for writing and beginning to write according to a preferred embodiment of the invention. Two different hand gestures are defined in the invention, which may be incorporated with an input method integrator of Microsoft Office IME, and are used to proceed with inputting a character. As shown in FIG. 5(A), the thumb will not be stretched out when in writing, and as shown in FIG. 5(B), the thumb will be stretched out when moving a cursor for writing. Therefore, according to the invention, the gesture of the thumb may be utilized to judge if a user is to input a character or purely to move a mouse.

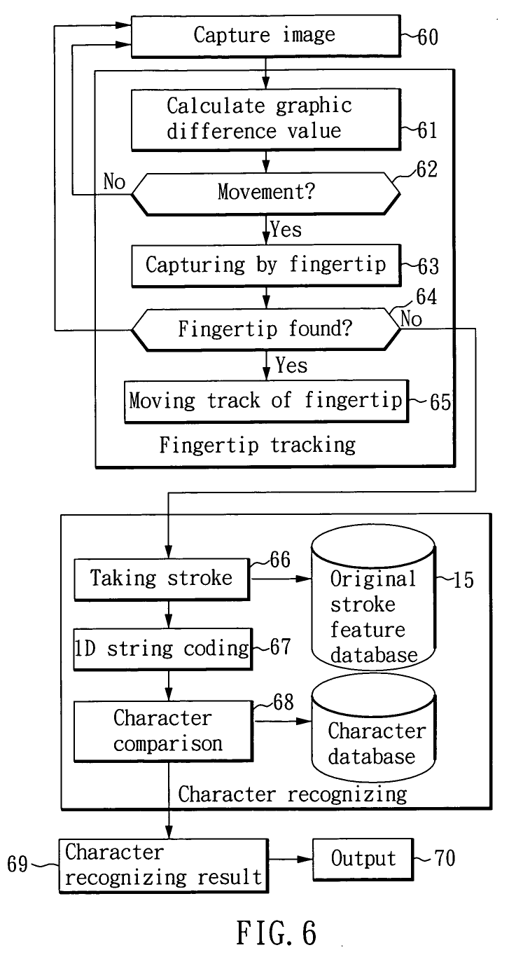

Please refer to FIG. 6, which is a flowchart showing a video-based character input method according to a preferred embodiment of the invention. The video-based character input apparatus of the invention comprises an image capturing unit 10, an image processing unit 11, a one-dimensional feature coding unit 12, a character recognizing unit 13, a display unit 14, a stroke feature database 15 for storing various strokes and their corresponding codes, and a character database 16 for storing Chinese, English, digits and symbols. Firstly, the image capturing unit 10 captures an image and transfers the image to the image processing unit 11 (step 60). The image processing unit 11 calculates a graphic difference value of the captured image to judge if there is a movement of an object (steps 61, 62). If not detecting occurrence of a movement, it captures an image again, and if detecting occurrence of a movement, it proceeds with capturing by a fingertip (step 63), and then judges if the fingertip is found (step 64). If the fingertip is found, it records the position of the fingertip and filters a moving track of the fingertip (step 65), and if not, it means that the user has finished the writing, the moving track is transferred to the one-dimensional feature coding unit 12. The one-dimensional feature coding unit 12 takes a stroke with respect to the moving track (step 66), searches the stroke feature database 15 and converts the stroke into a coding sequence in a one-dimensional string according to a time sequence (step 67). The character recognizing unit 13 proceeds with character comparison between the coding sequence in a one-dimensional string and the character database (step 68) to find out a character having the most similarity (step 69), using a dynamic time warp matching algorithm. Finally, the display unit 14 displays the verified character input from the character recognizing unit 13 (step 70).

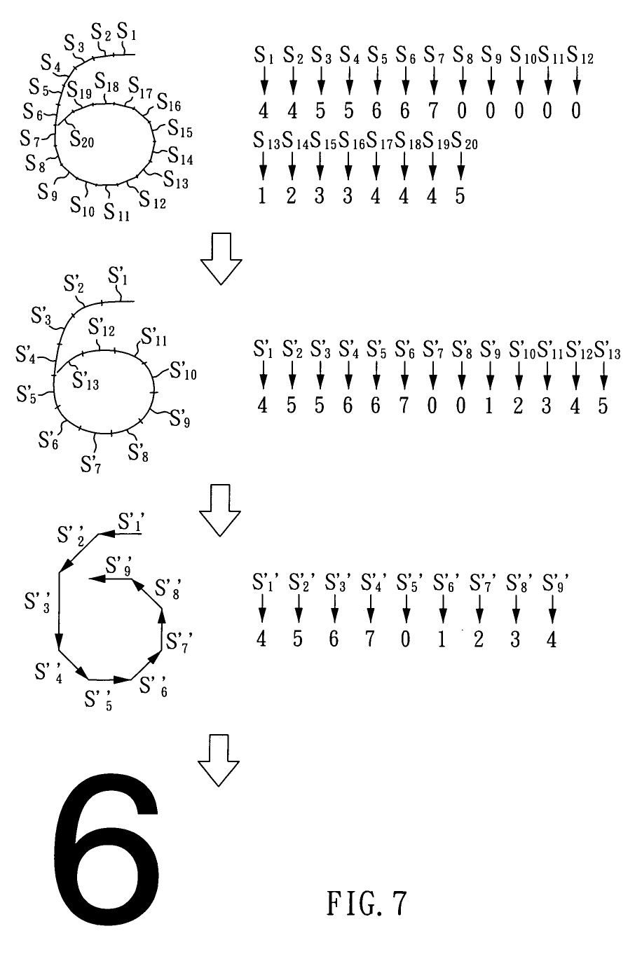

Please refer to FIG. 7, which is an exploded view of procedures for recognizing a character of “6” according to a preferred embodiment of the invention. After the image processing unit 11 filters out the moving track of “6”, the moving track is divided into a plurality of segments according to the time sequence, i.e. S₁-S₂₀ in FIG. 7, each segment corresponding to a directional value. Please concurrently refer to FIG. 2(A), showing a schematic diagram defining a stroke in eight directions. Segment S₁ falls within the interval of 157.5°-202.5°, meaning that the corresponding directional value of the segment S₁ is 4. The rest can be deduced accordingly. The corresponding directional value of the segment S₃ is 5, and the corresponding directional value of the segment S₅ is 6, and so on. Then, it proceeds with smoothing process with respect to the track so as to smooth the segments S₁-S₂₀ for smoothing segments S′₁-S′₁₃, in which several smoothing segments having directions changed in a pre-determined range are incorporated so as to obtain combining segments S″₁-S″₉. Each of the combining segments S″₁-S″₉ corresponds to a directional value. Based on the corresponding values of the combining segments, the moving track is divided into a number of strokes. In the embodiment, the corresponding directional value respectively of the combining segments S″₁-S″₅ is 4, 5, 6, 7 and 0, respectively, while the stroke constituted thereby is “ [symbol] ”. The corresponding directional value respectively of the combining segments S″₅-S″₉ is 0, 1, 2 , 3 and 4, respectively, while the stroke constituted thereby is “ [symbol] ”. Please refer to FIG. 2(B) simultaneously. The corresponding code respectively of the strokes “ [symbol] ” and “ [symbol] ” is “C” and “A”, respectively. Thus, the coding sequence in a one-dimensional string of 6 is “CA”. Finally, the character recognizing unit 13 finds out in the character database 16 a character “6” having the most similarity to the coding sequence in a one-dimensional string of “CA”.

Although the present invention has been explained in relation to its preferred embodiment, it is to be understood that many other possible modifications and variations can be made without departing from the scope of the invention as hereinafter claimed.

What is claimed is:

1. A video-based character input apparatus, comprising:
an image capturing unit for capturing an image;
a image processing unit for filtering a moving track of an object in the image;
a stroke feature database for storing various strokes and their corresponding codes;
a one-dimensional feature coding unit for taking a stroke with respect to the moving track and for searching the stroke feature database to convert the stroke into a coding sequence in a one-dimensional string according to a time sequence;
a character database for storing characters;
a character recognizing unit for proceeding with character comparison between the coding sequence in a one-dimensional string and the character database to find out a character having the most similarity; and
a display unit for displaying the character found out by the character recognizing unit.

2. The apparatus as claimed in claim 1, wherein the image capturing unit includes a network camera, an image capturing device in a mobile device, and an image capturing device in an embedded device.

3. The apparatus as claimed in claim 1, wherein the image processing unit proceeds with filtering the track by firstly detecting a graphic difference, then detecting a skin color, and finally picking out a moving track most corresponding to a point of the object.

4. The apparatus as claimed in claim 1, wherein the object includes a fingertip.

5. The apparatus as claimed in claim 1, wherein kinds of strokes stored in the stroke feature database include strokes in eight directions, semi-circles, and circles.

6. The apparatus as claimed in claim 1, wherein characters stored in the character database include Chinese, English, digits and symbols.

7. The apparatus as claimed in claim 1, wherein the character recognizing unit proceeds with character comparison using a dynamic time warp matching algorithm.

8. A method for inputting a character in a video-based character input apparatus, the video-based character input apparatus including an image capturing unit, a image processing unit, a one-dimensional feature coding unit, a character recognizing unit, a display unit, a stroke feature database and a character database, the method comprising the steps of:
(A) capturing an image via the image capturing unit;
(B) filtering a moving track of an object in the image via the image processing unit;
(C) proceeding with taking a stroke with respect to the moving track and searching the stroke feature database to convert the stroke into a coding sequence in a one-dimensional string according to a time sequence via the one-dimensional feature coding unit;
(D) proceeding with character comparison between the coding sequence in a one-dimensional string with the character database to find out a character having the most similarity via the character recognizing unit; and
(E) displaying the character found out by the character recognizing unit via the display unit.

9. The method as claimed in claim 8, wherein in step (B), the image processing unit proceeds with filtering the track by firstly detecting a graphic difference, then detecting a skin color, and finally picking out a moving track most corresponding to a point of the object.

10. The method as claimed in claim 8, wherein the image capturing unit includes a network camera, an image capturing device in a mobile device, and an image capturing device in an embedded device.

11. The method as claimed in claim 8, wherein the object includes a fingertip.

12. The method as claimed in claim 8, wherein kinds of strokes stored in the stroke feature database include strokes in eight directions, semi-circles, and circles.

13. The method as claimed in claim 8, wherein characters stored in the character database include Chinese, English, digits and symbols.

14. The method as claimed in claim 8, wherein the character recognizing unit proceeds with character comparison using a dynamic time warp matching algorithm.
